(19) United States
(12) Patent Application Publication
(10) Pub. No.: US 2006/0267475 A1
(43) Pub. Date: Nov. 30, 2006

(54) Field emission device and a method of forming such a device

(75) Inventors: Hugo Matthieu Visser, Eindhoven (NL); Marcus Antonius Verschuuren, Eindhoven (NL); Teunis Johannes Vink, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/554,605

(22) PCT Filed: Apr. 26, 2004
(86) PCT No.: PCT/IB04/50508

§ 371 Date: Oct. 27, 2005

(30) Foreign Application Priority Data
Apr. 28, 2003 (EP) 031011588

(51) Int. Cl. H01J 63/04; H01J 9/24

(52) U.S. Cl. 313/495; 445/24

(57) ABSTRACT

A field emission device (1) may be used for emitting electrons in, for example, a field emission display (FED). Field emission tips (40) are used for the emitting of electrons in the field emission device (1). In operation of the field emission device (1) a voltage is applied between a first electrode (4) having electrical contact with the field emission tip (40) and a second electrode (34) to make the field emission tip (40) emit electrons. To form a field emission tip (40) a layer of liquid material is applied on a substrate (2) provided with the first electrode (4). The layer of liquid material is embossed with a patterned stamp and subsequently cured to form a field emission tip structure (20). A conductive film (38) is applied on the field emission tip structure (20) to form a field emission tip (40) that has electrical contact with the first electrode (4).

### FIELD OF THE INVENTION

The present invention relates to a method of manufacturing a field emission device.

The present invention further relates to a field emission device.

### BACKGROUND OF THE INVENTION

A field emission device may be used as an electron source for a flat panel type display, the so called Field Emission Display (FED), which is a vacuum electronic device.

Field emission is a quantum-mechanical phenomenon in which electrons tunnel through a potential barrier at an outer surface of a suitable emitter material, as a result of an applied electric field. The presence of the electric field makes the width of the potential barrier at said outer surface finite, so that this potential barrier is permeable for electrons. Thus, electrons may be emitted from the field emitter material. A field emission device commonly employs a gate structure (also called triode structure). The gate structure includes field emitter material and two electrodes, namely a cathode electrode and a gate electrode. Between these electrodes, in operation, an electric field is formed which allows emission of electrons from the field emitter material, which is usually located adjacent to the cathode electrode.

In a field emission display, the field emission device employs two sets of electrodes, more particularly a set of cathode electrodes and a set of gate electrodes. The sets of electrodes generally define a passive matrix structure of rows and columns. Thereby, the electric field, and thus the electron emission current, may be modulated independently for each pixel on the display screen of the field emission display. For obtaining a sufficiently high strength of the electric field over the field emitter material, the cathode and gate electrodes should generally be close to each other. To achieve this, a dielectric layer is provided between the sets of electrodes.

U.S. Pat. No. 6,045,425 describes a method of manufacturing field emission tips that can be used for emitting electrons in a field emission device. The field emission tips, sometimes referred to as Spindt emitters, are formed in groups each having electrical contact with a cathode electrode and emitting electrons when voltages are applied to the cathode electrode and to the gate electrode corresponding to that particular group. The field emission tips of U.S. Pat. No. 6,045,425 are formed by high density plasma chemical vapour deposition in openings that have been formed in an insulator layer provided on a cathode. In a subsequent step excess deposited material is removed by etching a so called lift-off layer provided on the insulator layer. Further steps are then required to form a gate electrode. The method described in U.S. Pat. No. 6,045,425 involve many steps and is therefore time consuming and expensive. It is also difficult to ensure that all field emission tips on the field emission device are grown to the same dimensions during the vapour deposition. Thus there is a risk of uneven electron emission over the area of the field emission device.

### SUMMARY OF THE INVENTION

It is an object of the present invention to provide a method of forming a field emission device, said method being faster and cheaper than conventional methods.

This object is achieved by a method of forming a field emission device according to the preamble and comprising the steps of

providing a conductive layer on a substrate,

providing a layer of liquid material on the conductive layer,

engaging a patterned stamp with said layer of liquid material for embossing the layer of liquid material and forming at least one field emission tip structure therein,

curing the layer of liquid material, thereby forming a solidified, patterned dielectric layer having at least one solidified field emission tip structure, and

forming a conductive film on said at least one solidified field emission tip structure to bring it in electrical contact with the conductive layer.

The method of the invention decreases the number of steps necessary to manufacture high quality field emission tips. The control of the physical shape of the field emission tips is improved. The use of a patterned stamp is advantageous in that mass production of field emission devices is enabled.

The measure according to claim 2 has the advantage that it makes it easy to manufacture a field emission device having field emission tip structures and electrode structures that are very well aligned with each other since they are formed simultaneously and by the same patterned stamp. A proper alignment results in well defined emission characteristics which is important to obtain homogenous emission over a large area, such as in a field emission display. Another advantage is that the field emission tip structures and electrode structures are formed in one step only thereby reducing the number of steps required for manufacturing the field emission device.

The measure according to claim 3 has the advantage that it provides an efficient method of making structures, such as the field emission tip structures and, if present, the electrode structures, electrically conducting. Evaporated conductive material is well suited for electrically contacting the very small field emission tip structures with the conductive layer and still keep the tip of the field emission tip structure sharp. Metal films, such as tungsten and molybdenum films, that are well suited for electron emission can be efficiently applied by such vapour deposition.

The measure according to claim 4 has the advantage that the electrical contacting of the field emission tip structures to the conductive layer becomes much easier when excess dielectric material covering this layer is removed. Etching is a simple process that is well suited for reaching down between the small structures formed and to etch the excess dielectric material.

The measure of claim 5 has one advantage in that the coating protects the field emission tip structure and, if present, also the electrode structure from being etched in a subsequent etching step.

The measure of claim 6 has the advantage that the application of the coating may be used for providing a gate electrode on the electrode structure. Also the conductivity at the tip of the field emission tip structure may be improved.

The measure according to claim 7 has the advantage of providing an efficient protection of the field emission tip structure and, if present, also the electrode structure so that these structures are not etched in a subsequent etching step. The hydrophobic coating may be removed after the etching step so that e.g. a conductive film can be applied.

It is a further object of the present invention to provide a field emission device which is cheaper and easier to manufacture than conventional field emission devices and has a high and predictable quality.

This object is achieved by a field emission device according to the preamble and comprising

a substrate having provided thereon a conductive layer forming a first electrode,

a field emission tip that has been formed by means of embossing a layer of liquid material provided on the first electrode with a patterned stamp to form a field emission tip structure followed by curing the layer of liquid material and forming a conductive film substantially covering the field emission tip and electrically contacting it with said first electrode, and

a second electrode for applying, together with the first electrode, an electric field over the field emission tip.

An advantage with this field emission device is that is it cheap to manufacture and that it thereby can be used for mass production of field emission displays (FED's). A further advantage of the field emission device according to the invention is that the field emission tips have a high quality and predictable physical dimensions and electron emission properties making the electron emission even over the area of e.g. a screen comprised in the FED.

The measure according to claim 9 has the advantage that the field emission tip and the second electrode, which may be a gate electrode, are very well aligned with each other. A good alignment is crucial to the quality of the field emission device but is often difficult to obtain in mass production with prior art technology. By the simultaneous forming of the field emission tip structure and the electrode structure using a stamp carrying both patterns a good alignment is ensured for all field emission devices produced with such a stamp.

The measure according to claim 10 has the advantage of providing a sufficient electrical conductivity for both the gate electrode and the field emission tip, in particular at the tip thereof. The application of a coating by means of a stamp provides for low manufacturing costs and homogenous emission over a large area.

The measure according to claim 11 has the advantage of providing a sharp tip on the field emission tip structure. Such a sharp tip is preferable with respect to the efficient electron emission from the field emission tip.

Preferably the conductive film applied on the field emission tip has a thickness of 2-50 nm, still more preferably 5-15 nm. A thin conductive film is advantageous in that it will not have a substantial affect on the physical dimensions of the field emission tip structure. Thus the physical dimensions of the field emission tip structure are merely decided by the patterned stamp yielding a better control of the dimensions. A further advantage is that a thin conductive film will not substantially decrease the sharpness of the tip of the field emission tip. A sharp tip is advantageous for the electron emission properties. Preferably the conductive film is a metal film since metal films have a high conductivity also with rather thin films.

These and other aspects of the invention will be apparent from and elucidated with reference to the embodiments described hereafter.

### BRIEF DESCRIPTION OF THE DRAWINGS

The invention will now be described in more detail and with reference to the appended drawings in which:

FIGS. 1A-1J are cross sections and illustrate a method of forming a field emission device.

FIGS. 2A-2E are cross sections and illustrate an alternative method of forming a field emission device.

FIG. 3 is a cross section and illustrates yet another alternative method of forming a field emission device.

The Figures are diagrammatic and not to scale. The purpose is to illustrate a number of process steps rather than giving an exact representation of the micrometer scale structures. Corresponding components generally have the same reference numerals.

### DESCRIPTION OF PREFERRED EMBODIMENTS

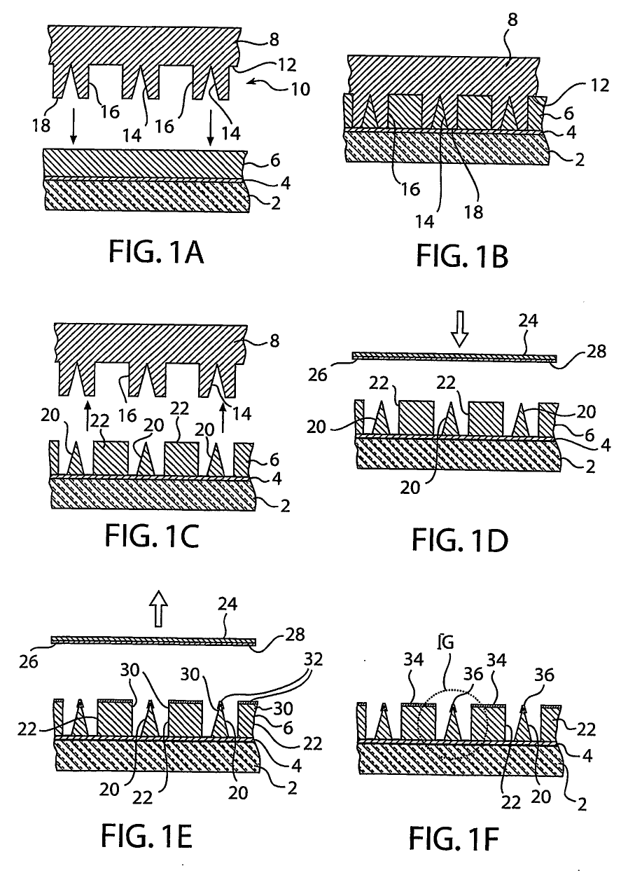

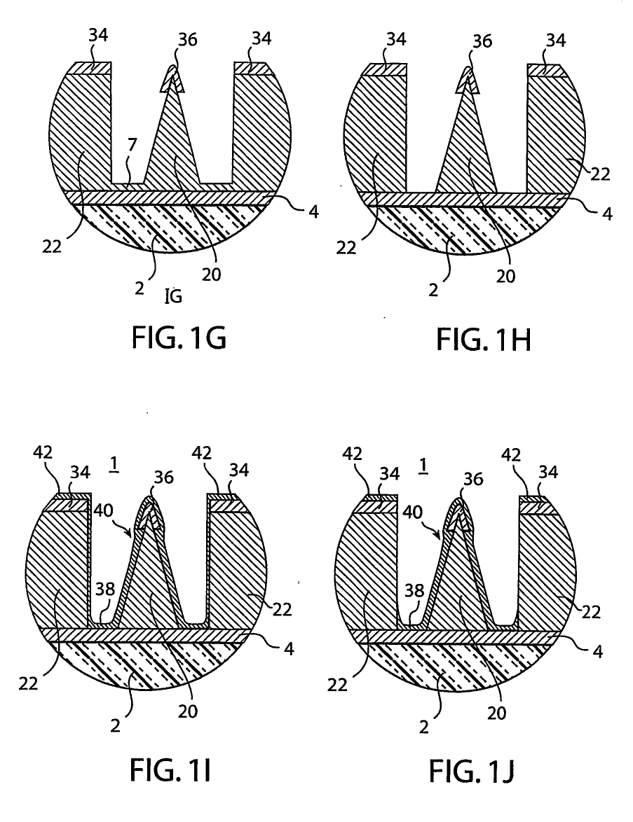

A gate structure (triode structure) for a field emission device is manufactured by means of an embodiment of the method according to the invention. In FIG. 1 the manufacturing of a field emission device 1 having a triode structure is illustrated.

A substrate 2, for example a glass plate, is firstly provided with a conductive layer in the form of a patterned cathode electrode 4. The cathode electrode 4 will form a first electrode in the triode structure. A layer 6 of liquid material is provided over the substrate 2 and the cathode electrode 4 as is indicated in FIG. 1A. The layer 6 preferably has a thickness of between 1 and 10 micrometer, and is deposited on the substrate 2 by means of, amongst others, a spinning process, a screen-printing technique or a dip-coating process. The liquid material is preferably a sol-gel type, such as a suspension of colloidal silica (Ludox TM50) and methyl tri-methoxy silane (MTMS). Alternatively, the liquid material comprises polyimide with a photosensitive compound. During a subsequent embossing step, similar to the embossing step described below, the polyimide can be cured by exposure with UV light.

An elastomeric stamp 8, which is for example made of PDMS (polydimethylsiloxane), which is a silicone rubber, is provided with a pattern 10 on its surface 12. The pattern 10 comprises conical recesses 14 and preferably cylindrical recesses 16. The recesses 14, 16 are surrounded by protrusions 18. The conical recesses 14 are well aligned with the cylindrical recesses 16.

As shown in FIG. 1B the surface 12 of the stamp 8 is brought into contact with the layer 6 of liquid material during an engaging step to emboss said layer 6 of liquid material and to transfer the pattern 10 on the surface 12 of the stamp 8 to the layer 6 of liquid material. During the embossing of the layer 6 liquid material is thus pushed away by the protrusions 18 but remains within the recesses 14, 16. Thereby, the layer 6 of liquid material is given an embossed pattern, which matches the pattern of recesses 14, 16 and protrusions 18 on the stamp 8. This process is called “soft lithography” or “liquid embossing”.

A first curing step is carried out wherein the layer 6 is heated to a temperature of 70 degrees Celsius for 2-10 minutes. This ensures that the layer 6 maintains its pattern during the subsequent step of removing the stamp 8 from the layer 6.

FIG. 1C shows that the stamp 8 is removed from the layer 6. As can be seen conical field emission tip structures 20 protrude at the locations on the layer 6 corresponding to the conical recesses 14. Cylindrical electrode structures 22 protrude at the locations on the layer 6 corresponding to the cylindrical recesses 16. The structures 20, 22 have a height from the cathode layer 4 of typically 1 to 10 micrometer depending on the original thickness of the layer 6 and the pattern of the stamp 8. The electrode structures 22 are aligned with the field emission tip structures 20 since the structures 22, 20 were made simultaneously with a stamp 8 having both the cylindrical recesses 16 and the conical recesses 14 on its surface 12.

After removing the stamp 8, a second curing step is carried out whereby the layer 6 is heated to an elevated temperature of preferably around 350 degrees Celsius during 30 minutes. During the second curing step, the liquid material in the layer 6 is converted to a solid dielectric layer 6. In case the layer of liquid material includes the above-mentioned sol-gel type suspension, the solid dielectric material comprises silicon dioxide and organically modified silicon oxide, and the dielectric constant of the solidified layer 6 is between 3 and 4.

FIG. 1D shows a secondary stamp 24. The stamp 24 carries a thin suspension 26 on a first surface 28. The suspension 26 could be a not cured colloidal suspension of metal particles, such as silver or gold particles. The suspension 26 could be applied to the stamp 24 by dipping the stamp in a bath of the suspension. It is also possible to apply the suspension 26 to the stamp 24 by contacting the stamp 24 with a secondary substrate (not shown) carrying the suspension 26. The suspension 26 could form a homogenous layer on the stamp 24 or could, more preferably, form a pattern corresponding to the electrode design on the field emission device.

FIG. 1E shows that the secondary stamp 24 has been brought into contact with the solidified layer 6 and that the suspension 26 has partly been deposited on protruding parts 30 of the field emission tip structures 20 and the electrode structures 22 thus forming a coating 32 of the suspension 26 on those protruding parts 30. After the deposition step the stamp 24 has then been removed again. The coating 32 is then cured at a temperature of about 300 degrees Celsius to become electrically conducting, with, in the case of a colloidal suspension 26 of silver particles, a resistivity of about 1.5 to 2 times the resistivity of bulk silver.

FIG. 1F shows the situation after curing the coating 32. The cured coating on the electrode structures 22 form second electrodes in the form of gate electrodes 34. The cured coating on the field emission tip structures 20 form caps 36 each protecting the sharp tip of the corresponding field emission tip structure 20.

FIG. 1G is an enlarged view of the area IG shown in FIG. 1F. In case some excess solidified liquid material 7 covering the cathode electrode 4 is present, as shown in FIG. 1G, a short wet chemical etch using an etchant comprising diluted (0.01 N) HF solution is performed to etch away the excess solidified liquid material 7.

FIG. 1H shows the result after the etching with HF. The excess solidified liquid material has been removed making the cathode electrode 4 exposed between the field emission tip structure 20 and the electrode structure 22. The gate electrode 34 has protected the electrode structure 22 from the etchant, although a certain isotropic back-etch may occur. In the same way the cap 36 has protected the tip of the field emission tip structure 20 from the etchant.

In a following step evaporated metal is deposited onto the gate electrode 34, the cap 36 and the field emission tip structure 20. The metal is preferably a metal with a high melting point since such metals are not easily removed by the sputtering that may occur in a display device containing the field emission device. Preferred examples of such metals include tungsten (W) and molybdenum (Mo). Preferably the metal is evaporated in a direction perpendicular to the substrate 2 such that no or only a small amount of material is deposited on the vertical side walls of the electrode structure 22. FIG. 1I shows the field emission device 1 after the deposition of the evaporated metal forming a conductive film 38 on the field emission tip structure 20 and the cap 36. The thickness of the conductive film 38 is typically 5 to 10 nm. The conductive film 38, the field emission tip structure 20 and the cap 36 together form a field emission tip 40 which is electrically contacted with the cathode electrode 4 by the conductive film 38 and which emits electrons when a potential is applied over the cathode electrode 4 and the gate electrode 34. The tip of the field emission tip 40 is sharp which is necessary for good electron emission properties. As can be seen from FIG. 1I some evaporated metal has been deposited on top of the gate electrode 34 forming a gate electrode coating 42 further improving the conductivity of the gate electrode 34.

To avoid any risk of short circuiting the gate electrode 34 a short metal etch could be performed to remove any metal deposited on the vertical walls of the electrode structure 22 and thus ensure that no direct electrical contact could occur between the gate electrode 34 and the cathode 4. This metal etch could, in the case of a conductive film 38 made of tungsten, be made with an etchant containing hydrogen peroxide, ammonia and water. The etching is performed to such a degree that an average of about 1 nm of the conductive film 38 is etched away. FIG. 1J shows the final field emission device 1 after such metal etch. As can be seen in FIG. 1J the thin metal layer has been removed from the vertical walls of the electrode structure 22. The short metal etch has had a very limited effect on the conductive layer 38 of the field emission tip 40.

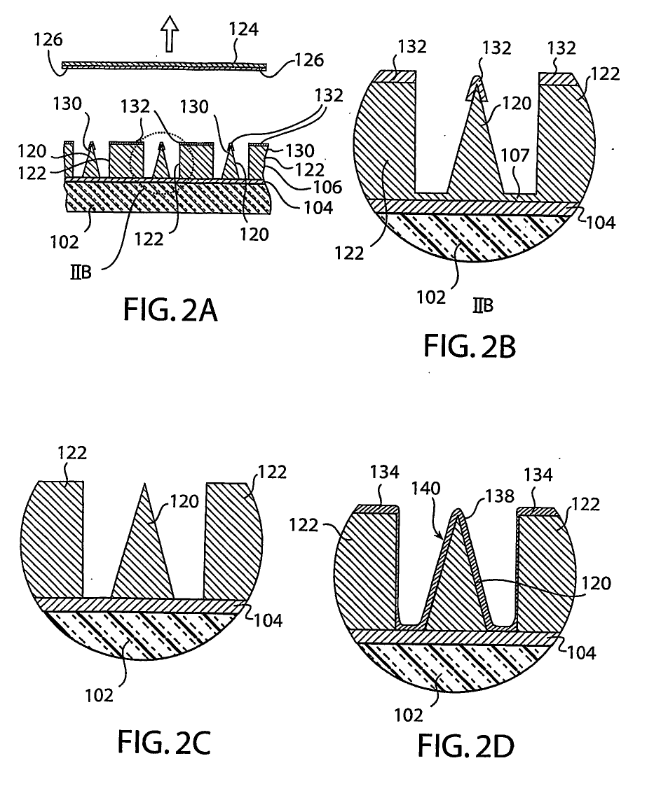

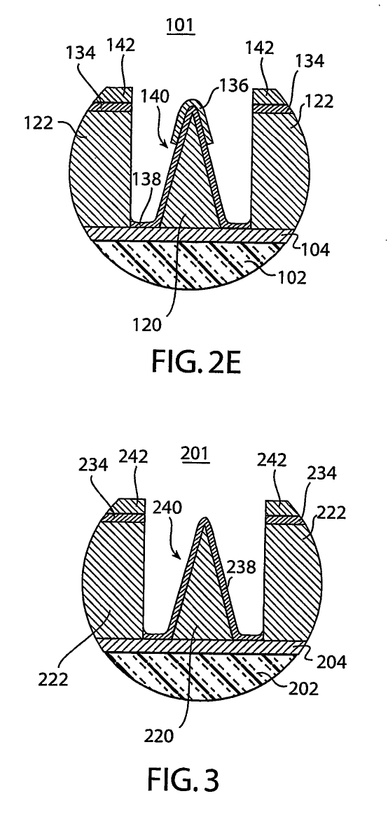

FIGS. 2A to 2E show an alternative embodiment of the invention. By this alternative embodiment field emission tip structures 120 and electrode structures 122 are firstly formed by embossing a layer 106 of liquid material on a cathode electrode 104 and a substrate 102 followed by curing according to the same principles that have been described with reference to FIGS. 1A to 1C above. After curing the field emission tip structures 120 and electrode structures 122 they are exposed to a UV-ozone treatment or an oxygen plasma to make the surface of the solidified material 106 more hydrophilic, i.e. to have what is called a reactive OH terminated surface. A secondary stamp 124 is used to apply a hydrophobic monolayer 126 (e.g. organically modified silanes) to protruding parts 130 of the field emission tip structures 120 and the electrode structures 122. Preferably the stamp 124 has a low modulus of elasticity such that the hydrophobic layer 126 easier comes into good contact with tip portions of the field emission tip structures 120. FIG. 2A shows the situation just after retracting the secondary stamp 124 having applied its monolayer to the protruding parts 130, which thereby have become covered with a hydrophobic coating 132.

FIG. 2B is an enlarged view of the area IIB in FIG. 2A. In case some excess solidified liquid material 107 covering the cathode electrode 104 is present, a wet chemical etch with a diluted HF (0.01 N) solution is performed to remove the excess solidified material 107 and uncover the cathode electrode 104 in the areas between the structures 120, 122. During the etching the field emission tip structure 120 and the electrode structure 122 are protected by the hydrofobic coating 132. Thus the tip of the field emission tip structure 120 remains sharp. After removing the excess solidified material 107 by said etching the hydrophobic coating 132 has fulfilled its purpose and is removed by a short UV-ozone treatment or a treatment with an oxygen plasma. FIG. 2C indicates the shape of the structures 120, 122 after the etching and the subsequent removal of the hydrophobic coating.

In the following step an evaporated metal is deposited onto the electrode structure 122 and the field emission tip structure 120 to form a conductive film 138. Preferably the evaporated metal is applied in a direction perpendicular to the substrate 102 such that only a small amount of material is deposited on the vertical side walls of the electrode structure 122. The metal is preferably a metal with a high melting point since such metals are not easily removed by the sputtering that may occur in a display device containing the field emission device. Preferred examples of such metals include tungsten (W) and molybdenum (Mo). FIG. 2D shows the structures 120, 122 after deposition of a conductive film 138 by vapor deposition to a thickness of about 5-10 nm. As can be seen the film 138 together with the field emission tip structure 120 form a field emission tip 140 which is in electrical contact with the cathode electrode 104. The metal deposited on the electrode structure 122 forms a gate electrode 134. As is indicated in FIG. 2D a thin (less than 1 nm) layer of metal has been deposited also on the vertical walls of the electrode structure 122. To avoid any risk of short-circuiting the gate electrode 134 to the cathode electrode 104 a short metal etch could be performed. This metal etch could, in the case of a conductive film 138 made of tungsten, be made with an etchant containing hydrogen peroxide, ammonia and water. This etchant is isotropic, which means that the etching effect is the same in all spatial directions. The etching is performed to such a degree that an average of about 1 nm of the conductive film 138 is etched away thus avoiding any electrical contact between the gate electrode 134 and the cathode electrode 104 or the field emission tip 140.

In some cases the gate electrode 134 may need improved conductivity. In such cases a suspension comprising a not cured colloidal suspension of metal particles, such as silver or gold particles could be applied by a third stamp (not shown) in accordance with the same principles that has been described above with reference to FIG. 1D to FIG. 1F. FIG. 2E shows the resulting field emission device 101 after the above mentioned metal etch and the application and curing of the colloidal suspension. After applying and curing such a colloidal suspension the gate electrode 134 comprises an extra conductive layer 142 of a cured suspension of metal particles and the field emission tip 140 has a cap 136 of the same material. As is clear from FIG. 2E the metal etch has removed the thin layer of the evaporated metal on the vertical walls of the electrode structure 122 thus avoiding the risk of any short-circuiting.

The third stamp used when applying the colloidal suspension of metal particles had a low modulus of elasticity. Thus the colloidal suspension covered also the tip portions of the field emission tip 140 to form said cap 136. The extra conductive layer 142 and the cap 136 will improve the conductivity of the gate electrode 134 and the field emission tip 140 respectively.

FIG. 3 shows an alternative embodiment to that of FIG. 2E as regards the final step in forming the field emission device. In this alternative embodiment a colloidal suspension of metal particles has been applied with the help of a third stamp (not shown) having a high modulus of elasticity. The field emission device 201 shown in FIG. 3 has a substrate 202, a cathode 204 and electrode structures 222 having gate electrodes 234 of deposited metal vapour which are covered by a layer 242 of a cured colloidal suspension of metal particles. The field emission device 201 further comprises a field emission tip 240 comprising a field emission tip structure 220 covered by a conductive film 238 of deposited metal vapour. Due to the high modulus of elasticity of the third stamp no cap of cured colloidal suspension has been applied to the tip of the field emission tip 240, which thereby has a very sharp tip.

It will be appreciated that numerous modifications of the embodiments described above are possible within the scope of the appended claims.

Thus, for example, it would be possible to first form the field emission tip structure with an alfa-stamp and then form the electrode structure with a patterned beta-stamp or another method. It will, however, be appreciated that the simultaneous forming of the field emission tip structure and the electrode structure using a patterned stamp provided with both patterns as described above is preferable since the alignment of the field emission tip structure and the electrode structure is much easier and the number of steps is reduced.

It will be appreciated that the time and temperatures employed for curing the layer of liquid material after embossing are adapted to the material in question. The curing at ambient temperature may be suitable for some materials, whereas other materials require high temperatures for curing.

It is possible to form, as described above, only one or a few field emission tip structures and, if present, electrode structures, by embossing with a patterned stamp. It should be appreciated, however, that it is preferable to form several field emission tip structures and, if present, electrode structures in one embossing action. Still more preferably all field emission tip structures and electrode structures required for one field emission device, serving, as an example, an entire FED, should be formed in one embossing action in order to make all the field emission tips well aligned with each other and with their respective electrode structures.

To summarize a field emission device may be used for emitting electrons in, for example, a field emission display (FED). Field emission tips may be used for the emitting of electrons in the field emission device. In operation of the field emission device a voltage is applied between a first electrode having electrical contact with the field emission tip and a second electrode to make the field emission tip emit electrons. To form a field emission tip a layer of liquid material is applied on a substrate provided with the first electrode. The layer of liquid material is embossed with a patterned stamp and subsequently cured to form a field emission tip structure. A conductive film is applied on the field emission tip structure to form a field emission tip that has electrical contact with the first electrode.

1. A method of manufacturing a field emission device (1) comprising the steps of
providing a conductive layer (4) on a substrate (2),
providing a layer (6) of liquid material on the conductive layer (4),
engaging a patterned stamp (8) with said layer (6) of liquid material for embossing the layer (6) of liquid material and forming at least one field emission tip structure (20) therein,
curing the layer (6) of liquid material, thereby forming a solidified, patterned dielectric layer (6) having at least one solidified field emission tip structure (20), and
forming a conductive film (38) on said at least one solidified field emission tip structure (20) to bring it in electrical contact with the conductive layer (4).

2. A method according to claim 1, wherein the patterned stamp (8) comprises patterns (14, 16, 18) for forming at least one field emission tip structure (20) and at least one electrode structure (22) aligned with the tip structure (20), said step of embossing resulting in the simultaneous formation of at least one field emission tip structure (20) and at least one electrode structure (22) aligned therewith in the layer (6) of liquid material.

3. A method according to claim 1, wherein the step of forming the conductive film (38) comprises evaporating a conductive material onto the solidified, patterned dielectric layer (6).

4. A method according to claim 1, wherein an etching step is performed to remove excess dielectric material (7) from the conductive layer (4) prior to the step of forming the conductive film (38).

5. A method according to claim 1, wherein the step of curing the layer (6) of liquid material is followed by applying a coating (32) on protruding parts (30) of the solidified, patterned dielectric layer (6).

6. A method according to claim 5, wherein the coating is a conductive coating (32).

7. A method according to claim 5, wherein the coating is a hydrofobic coating (132).

8. A field emission device, comprising
a substrate (2) having provided thereon a conductive layer (4) forming a first electrode (4),
a field emission tip (40) that has been formed by means of embossing a layer (6) of liquid material provided on the first electrode (4) with a patterned stamp (8) to form a field emission tip structure (20) followed by curing the layer (6) of liquid material and forming a conductive film (38) substantially covering the field emission tip (40) and electrically contacting it with said first electrode (4), and
a second electrode (34) for applying, together with the first electrode (4), an electric field over the field emission tip (40).

9. A field emission device according to claim 8, wherein the field emission tip structure (20) of the field emission tip (40) has been formed simultaneously with an electrode structure (22) being aligned therewith by embossing said layer (6) of liquid material with a patterned stamp (8) having patterns (14, 16, 18) for forming the field emission tip structure (20) and the electrode structure (22), said electrode structure (22) supporting the second electrode (34) and electrically isolating it from the first electrode (4).

10. A field emission device according to claim 9, wherein conductive coatings (32) have been applied to protruding parts (30) of both the field emission tip structure (20) and the electrode structure (22) by means of a secondary stamp (24).

11. A field emission device according to claim 8, wherein the field emission tip (40) has a pyramidal or conical shape.

12. A field emission device according to claim 8, wherein the conductive film (38) has been formed by means of the deposition of an evaporated metal, the thickness of the conductive film (38) being 2-50 nm.
